(19) United States
(12) Patent Application Publication
(10) Pub. No.: US 2022/0379801 A1
(43) Pub. Date: Dec. 1, 2022

(54) SYSTEM FOR CONTROLLING AT LEAST ONE HEADLIGHT OF A MOTOR VEHICLE

(71) Applicant: RENAULT S.A.S, Boulogne-Billancourt (FR)

(72) Inventors: Guillaume GODARD, Guyancourt (FR); Herve GUENAUD, Saint Remy Les Chevreuses (FR); Christophe MAADED, Rueil Malmaison (FR)

(73) Assignee: RENAULT S.A.S, Boulogne-Billancourt (FR)

(21) Appl. No.: 17/776,509

(22) PCT Filed: Oct. 21, 2020
(86) PCT No.: PCT/EP2020/079603

§ 371 Date: May 12, 2022

(30) Foreign Application Priority Data
Nov. 14, 2019 (FR) FR 1912730

(51) Int. Cl. B60Q 1/14; G06V 10/141

(52) U.S. Cl. CPC B60Q 1/143; G06V 10/141; B60Q 2300/056; B60Q 2300/41

(57) ABSTRACT

A system controls at least one headlight of a motor vehicle provided with at least one light-emitting diode. The system includes at least one camera including a calculator suitable for determining the presence of at least one vehicle to be detected in the area in front of the motor vehicle and suitable for determining the shape of a shadow zone around at least one detected vehicle such that the latter is not blinded by the light emitted by the at least one light-emitting diode of the headlight, a controller for controlling the headlight. The controller is suitable for controlling the state of each light-emitting diode according to the operating state of the headlight and the shape of the shadow zone around the detected vehicle.

### TECHNICAL FIELD

The technical field of the invention is the control of the lighting of motor vehicles, and more particularly the control of the adaptive lighting of the high beams of such vehicles.

### PRIOR ART

The adaptive driving beam (ADB) function is a function creating shadow zones in the high beam located on cars situated facing the host vehicle in order not to dazzle them. This function is currently produced by three major components, a camera, a lighting computer dedicated to the function (Light Control Unit) and dedicated computers in each of the two headlights (“ADB driver LED”). The aim of the camera is to detect and locate the target vehicles on the road and transmit the information on position and width of the target vehicles to the lighting computer. The lighting computer calculates the shadow zone to be produced on the road in order to envelop the target car and the light-free angular portion of the high beam that needs to be produced for each of the headlights. Each LED driver incorporated in the headlights receives the angular information and drives the activation or the extinguishing of each of the LEDs of the high beam to create a shadow zone on the target vehicle.

There is a need to reduce the costs of production of such functions.

### SUMMARY OF THE INVENTION

A subject of the invention is a control system for at least one headlight of a motor vehicle provided with at least one light-emitting diode, comprising

at least one camera comprising computation means capable of determining the presence of at least one vehicle to be detected in the scene in front of the motor vehicle and capable of determining the form of a shadow zone around at least one detected vehicle such that it is not blinded by the light emitted by the light-emitting diode of the headlight,
a control means of the headlight capable of controlling the state of each light-emitting diode as a function of the state of operation of the headlight and of the form of the shadow zone around the detected vehicle.

The control means may receive information from the camera.

The motor vehicle may comprise an electronic control means capable of transmitting the state of operation of the headlight.

The state of operation of the headlight may comprise a high beam state of operation, a partial high beam state of operation and an off state.

The control system offers the advantage of reducing the number of control and processing means employed.

### BRIEF DESCRIPTION OF THE DRAWINGS

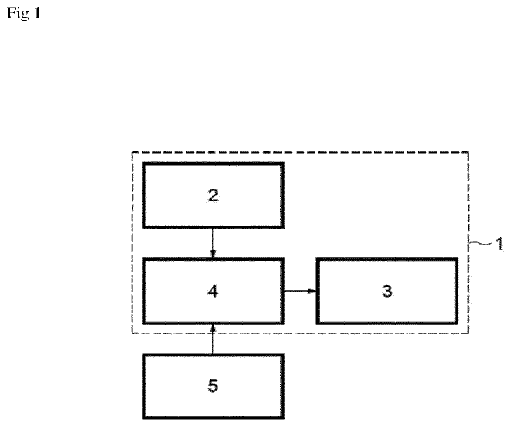

Other aims, features and advantages of the invention will emerge on reading the following description, given purely as a nonlimiting example and with reference to the attached drawings in which [FIG. 1] illustrates a control system for at least one headlight of a motor vehicle.

### DETAILED DESCRIPTION

The figure [FIG. 1] shows a lighting control system 1 of a motor vehicle comprising a camera 2, at least one headlight 3 comprising at least one light-emitting diode LED, at least one control means 4 of the or each headlight linked to an electronic control means 5. This control means consists for example of a control means of a host vehicle. In a particular embodiment, the control means 4 of the headlights is linked to the headlights 3 via a control gateway.

The camera 2 is provided with computation means and a memory. These computation means consist of hardware and software means embedded in a computer provided in the camera, the computation means being duly programmed to detect, by image processing, the presence of a vehicle to be detected in a scene around the host vehicle. The camera 2 performs an acquisition of images of the scene in front of the vehicle and the detection of vehicles present in the scene via its computation means. The vehicles present in the scene comprise vehicles being followed and approaching vehicles. The camera 2 also performs the determination of the shadow zone to be produced around each detected vehicle to avoid dazzling by the headlights.

This shadow zone constitutes a zone of the scene in front of the host vehicle which must not be lit by the headlights although it is within their range.

The camera 2 transmits the shadow zones to be produced to the control means 4 of the headlights which controls the LEDs to switch them on or keep them switched on as a function of the shadow zones to be produced that are received from the camera 2 and of the mode of operation of the headlights 3 that is received from the electronic control means 5 of the vehicle.

Thus, the control means 4 transmits specifically to each LED an activation or deactivation signal in order to configure and shape the lighting provided by the headlight to provide effective lighting while avoiding dazzling by generating shadow zones in the lit scene.

1. A control system for at least one headlight of a motor vehicle provided with at least one light-emitting diode, comprising:
at least one camera comprising computation means for determining the presence of at least one vehicle to be detected in the scene in front of the vehicle and for determining the form of a shadow zone around at least one detected vehicle such that it is not blinded by the light emitted by the at least one light-emitting diode of the headlight,
a control means of the headlight for controlling the state of each light-emitting diode as a function of the state of operation of the headlight and of the form of the shadow zone around the detected vehicle.

2. The control system as claimed in claim 1, wherein the control means receives information from the camera.

3. The control system as claimed in claim 1, wherein the motor vehicle comprises an electronic control means for transmitting the state of operation of the headlight.

4. The control system as claimed in claim 1, wherein the state of operation of the headlight comprises a high beam state of operation, a partial high beam state of operation and an off state.

5. The control system as claimed in claim 2, wherein the state of operation of the headlight comprises a high beam state of operation, a partial high beam state of operation and an off state.

6. The control system as claimed in claim 3, wherein the state of operation of the headlight comprises a high beam state of operation, a partial high beam state of operation and an off state.
